(19) United States
(12) Patent Application Publication
(10) Pub. No.: US 2004/0131787 A1
(43) Pub. Date: Jul. 8, 2004

(54) Aqueous based tire dressing compositions and methods of making

(75) Inventor: Jiafu Fang, Spring, TX (US)

Correspondence Address: JENKENS & GILCHRIST, 1401 MCKINNEY, SUITE 2700, HOUSTON, TX, 77010, US

(73) Assignee: Pennzoil-Quaker State Company, Houston, TX (US)

(21) Appl. No.: 10/722,217

(22) Filed: Nov. 25, 2003

Related U.S. Application Data
(60) Provisional application No. 60/429,262, filed on Nov. 26, 2002.

(51) Int. Cl. B05D 3/02

(52) U.S. Cl. 427/385.5

(57) ABSTRACT

The present invention relates to aqueous-based tire dressing compositions suited for surface treatment of rubber tires of automobiles, bicycles and so forth. The present invention provides an aqueous-based tire dressing composition for tires whereby their overall appearance is rendered more glossy and lustrous, and further where the aqueous-based tire dressing composition protects the surface of the tire.

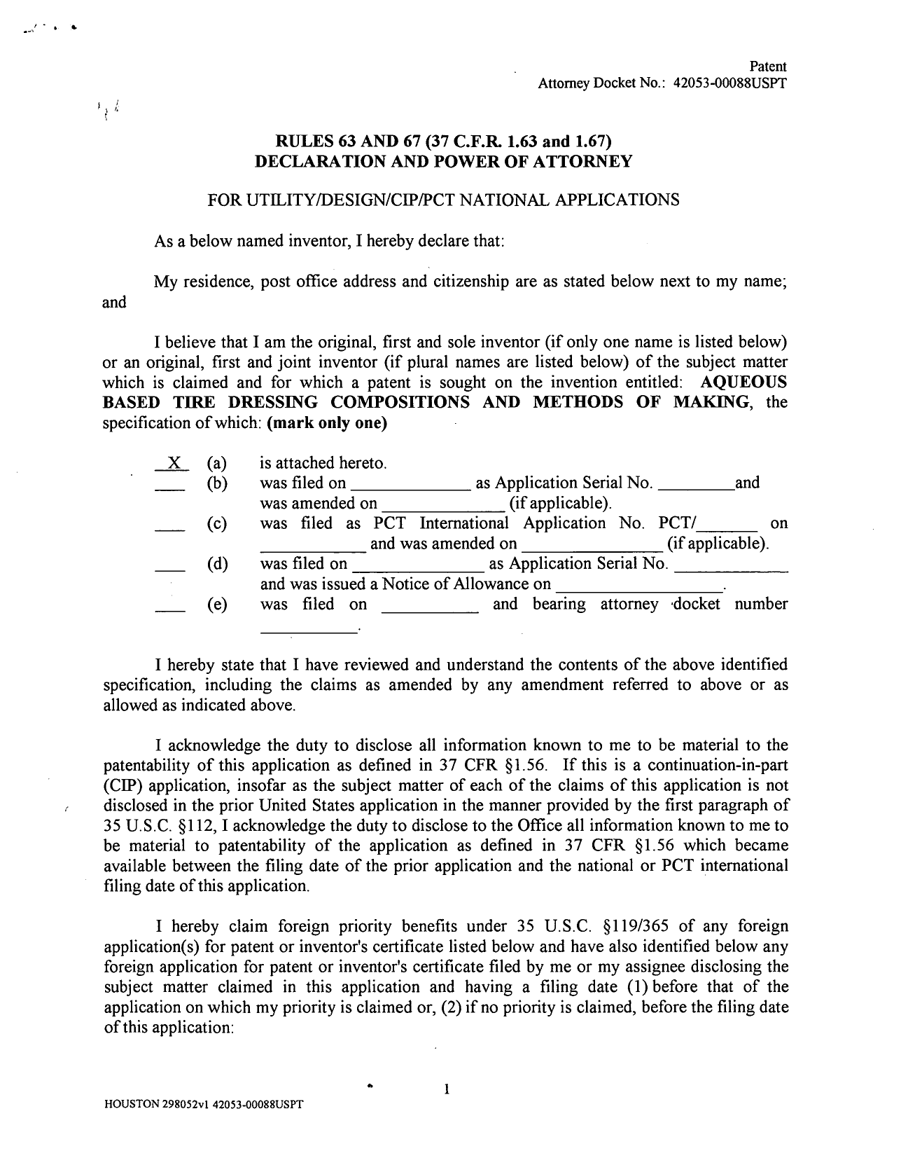

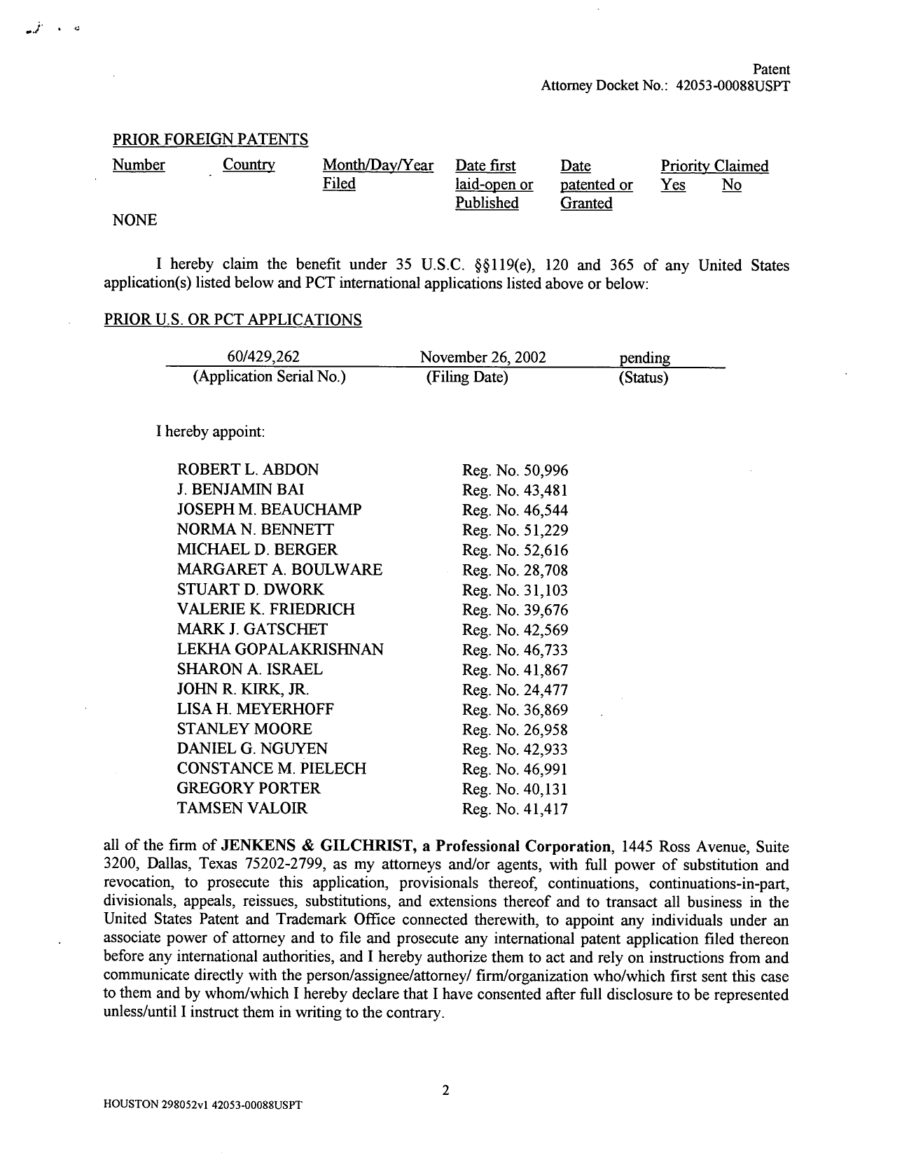

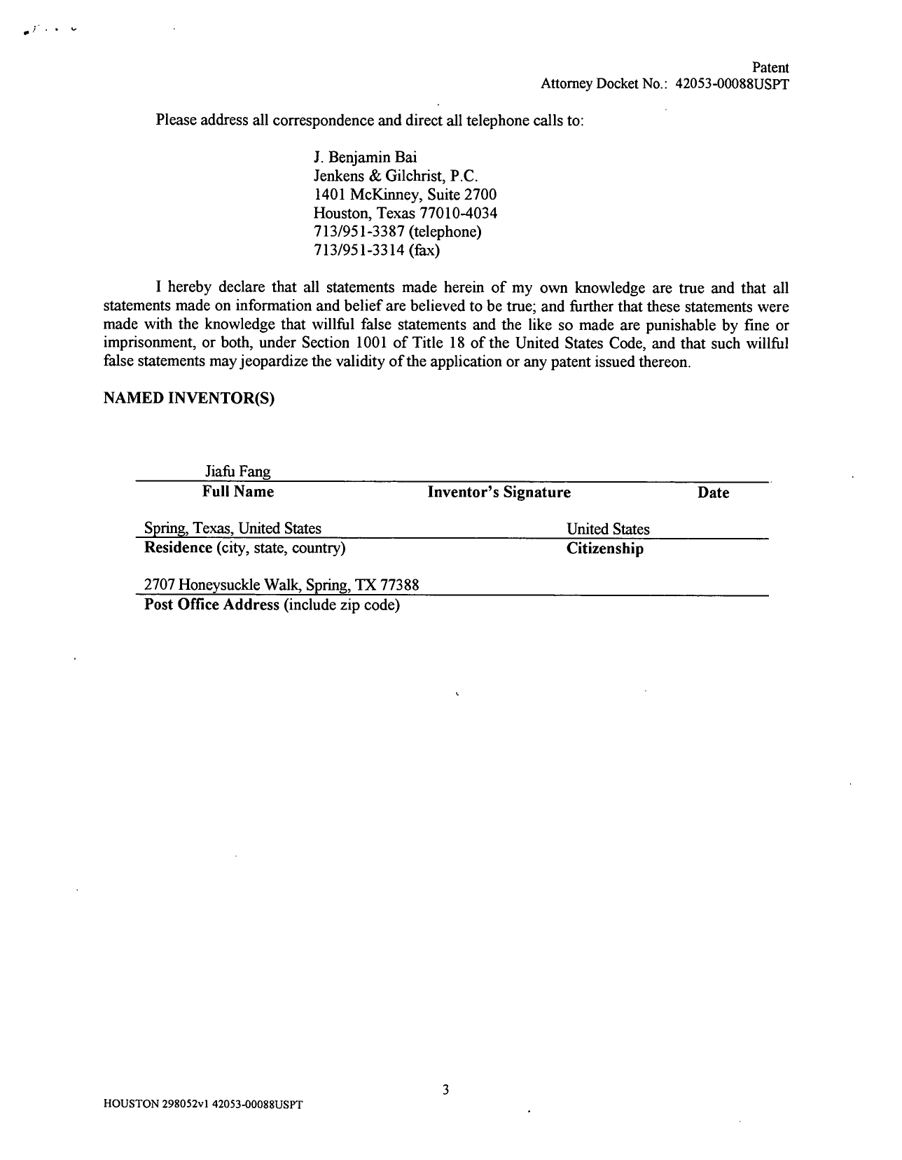

### CROSS REFERENCES TO RELATED APPLICATIONS

This patent application claims the benefit of U.S. Provisional Application No. 60/429,262, filed Nov. 26, 2002.

### STATEMENT REGARDING FEDERALLY SPONSORED RESEARCH

Not applicable.

### TECHNICAL FIELD OF THE INVENTION

The present invention relates to an aqueous-based tire dressing composition for tires of cars, bicycles and the like. This composition not only imparts gloss even to old lusterless tires but also coats the tire with a protective coating.

### BACKGROUND OF THE INVENTION

As the mileage on a tire increases, the sidewall rubber surfaces often become dull and unattractive. This is due to various causes including wind, weather, sunlight, scratching, abrasion from dirt, and other chemical and physical reactions. Many products are available today on the market for tire dressing usage to address these adverse effects. These products are referred to hereinafter as “tire dressing products”. Many of these products restore older appearance from a dull, weathered appearance to a shiny, bright, and like-new condition. For example, conventionally a dispersion of the silicone fluids in a petroleum distillate or a conventional oil in water silicone emulsion system with milky or opaque appearance are often used to restore the attractive, bright, shiny, and like-new appearance on the tire surface. Typically conventional tire dressing formulas for dressing and appearance applications are products containing both high viscosity and low viscosity silicone fluids blended in petroleum distillates or products containing silicone emulsions prepared in aqueous systems with milky white and opaque appearance. When applied to a tire surface, the silicone composition forms a liquid coating which develops a desired shiny appearance due to the unique structure of the silicone layer formed on the tire surfaces.

A solution or dispersion of silicone oil or wax in an organic solvent and an aqueous emulsion prepared therefrom with the aid of a surfactant are generally employed are generally employed as tire dressing agents. However, while these agents impart good gloss and acceptable water repellency to tires, they are readily stripped off by rain and dust so that the effects are unavoidably transitory or short-lived.

Therefore, there is a need for an aqueous-based tire dressing and a method of making such a composition which insures long-lasting gloss and protection to the tires after application.

### SUMMARY OF THE INVENTION

An embodiment of the invention relates to an aqueous-based tire dressing composition comprising a film-forming polymer liquid dispersion. Another embodiment of the invention relates to a method of forming a dried, resilient, glossy coating on a tire, comprising, applying a tire dressing composition to a surface of a tire, the tire-dressing composition comprising a film-forming polymer liquid dispersion.

### BRIEF DESCRIPTION OF THE DRAWINGS

Not applicable.

### DESCRIPTION OF EMBODIMENTS OF THE INVENTION

The embodiments of the invention provide aqueous-based tire dressing compositions that are capable of forming a durable, shiny, protective coating on a tire. The tire dressing composition of the invention exhibits good shine durability under wet weather conditions. A film-forming polymer capable of forming a coating, and providing an attractive, bright, shiny, like-new tire appearance, having water wash and detergent wash resistance can be used in the embodiments of the invention. Suitable compositions of the invention are preferably able to be handled by simple application methods such as sponging onto the tire surface.

In accordance with embodiments of the invention, the tire dressing composition comprises at least a film-forming polymer liquid dispersion. Preferred compounds used as film-forming polymer liquid dispersions include, but are not limited to, aqueous polyurethane dispersions; urethane-acrylic copolymers; natural rubber lattices, pre-vulcanized rubber latex; or synthetic rubber lattices. In an embodiment of the invention the film-forming polymer dispersion is present at a concentration of 20%-100% by weight of the composition. In an alternate embodiment of the invention, the film-forming polymer dispersion is preferably present at a concentration of 40%-80% by weight of the composition. In an embodiment of the invention, the aqueous polyurethane dispersions comprise, solids content of at least 20% by weight, or more preferably 30% by weight; volatile organic compounds at less than 20% by weight, more preferably less than 10% by weight, and most preferably less than 3% by weight; a pH range of 4-10, or more preferably between 5.5 and 9.5; and a viscosity ranging from 10 to 10,000 cps, or more preferably between 50 to 5000 cps.

In an embodiment of the invention, the tire dressing composition optionally comprises one or more of an antifoaming or defoaming agent, a wetting agent, a thickener, a pigment, a biocide, an antioxidant, a ultraviolet/visible light stabilizer, a coalescent, a plasticizer, an adhesion promoter, a leveling agent or water.

In an embodiment of the invention, an optional antifoaming or defoaming agent is present at a concentration of up to 2% by weight of the composition. In another embodiment of the invention, the antifoaming or defoaming agent is present at a concentration of 0.05 to 1% by weight of the composition. The antifoaming or defoaming agents used in the invention include, but are not limited to, silcone defoamers, silicone antifoamers, non-silicone defoamers, non-silicone antifoamers and mixtures thereof.

In a further embodiment of the invention, an optional wetting agent is present at a concentration of up to 4% by weight of the composition. In another embodiment of the invention, the wetting agent is present at a concentration of 0.1 to 2.5% by weight of the composition. The wetting agents used in the invention include, but are not limited to, non-ionic wetting agents, non-silicone wetting agents and mixtures thereof.

In an embodiment of the invention, an optional thickener is present at a concentration of up to 3% by weight of the composition. In another embodiment of the invention, the thickener is present at a concentration of 0.1 to 2.0% by weight of the composition. The thickeners used in the invention include, but are not limited to, acrylic acid-based polymers, hydroxyethylcellulose, polyacrylic-based thickeners, sodium silicate and mixtures thereof.

In an embodiment of the invention, an optional pigment is present at a concentration of up to 20% by weight of the composition. In another embodiment of the invention, the pigment is present at a concentration of 1 to 10% by weight of the composition. The pigments used in the invention include, but are not limited to, titanium dioxide, carbon black, mica, zinc oxide, calcium carbonate, clay and mixtures thereof.

In an embodiment of the invention, an optional biocide is present at a concentration of up to 4% by weight of the composition. In another embodiment of the invention, the biocide is present at a concentration of 0.05 to 2% by weight of the composition. The biocides used in the invention include, but are not limited to, 2-n-octyl-4-isothiazolin-3-one, Polyphase, cationic polymeric biocides, 1,2-benzisothiazolin-3-one, sodium 2-pyridinethiol-1-oxide and mixtures thereof.

In an embodiment of the invention, an optional antioxidant is present at a concentration of up to 5% by weight of the composition. In another embodiment of the invention, the antioxidant is present at a concentration of 0.1 to 3% by weight of the composition. The antioxidants used in the invention include, but are not limited to, hindered phenols, hindered aromatic amines and mixtures thereof.

In an embodiment of the invention, an optional ultra-violet/visible light stabilizer is present at a concentration of up to 5% by weight of the composition. In another embodiment of the invention, the light stabilizer is present at a concentration of 0.1 to 2% by weight of the composition. The light stabilizers used in the invention include, but are not limited to, inorganic stablizer compounds such as carbon black, micronized titanium dioxide, organic stabilizer compounds and mixtures thereof.

In an embodiment of the invention, an optional coalescent agent is present at a concentration of up to 8% by weight of the composition. In another embodiment of the invention, the coalescent agent is present at a concentration of 0.1 to 4% by weight of the composition. The coalescent agents used in the invention include, but are not limited to, ester alcohols, glycol methyl ethers and mixtures thereof.

In an embodiment of the invention, an optional plasticizer is present at a concentration of up to 15% by weight of the composition. In another embodiment of the invention, the plasticizer is present at a concentration of 1 to 10% by weight of the composition. The plasticizers used in the invention include, but are not limited to, polypropylene glycol dibenzoate, alkyl benzyl phthalates, 2,2,4-trimethyl-1,3-pentanediol diisobutyrate, bis(2-ethylhexyl) phthalate, benzoate esters, and mixtures thereof.

In an embodiment of the invention, an optional adhesion promoter is present at a concentration of up to 5% by weight of the composition. In another embodiment of the invention, the adhesion promoter is present at a concentration of 0.1 to 3% by weight of the composition. The adhesion promoters used in the invention include, but are not limited to, aminopropyltriethoxysilane, diaminosilane, triaminosilane, chlorosilane, organofunctional silane, alkylsilanes and mixtures thereof.

In an embodiment of the invention, an optional leveling agent is present at a concentration of up to 5% by weight of the composition. In another embodiment of the invention, the leveling agent is present at a concentration of 0.1 to 2.5% by weight of the composition. The leveling agents used in the invention include, but are not limited to, polyamides, tributoxyethyl phosphate and mixtures thereof.

In certain embodiments of the invention, water is present at a sufficient concentration to make up the balance of the tire dressing composition.

In certain embodiments of the invention, glittering pigments are optionally added to the composition to enhance the appearance of the coating.

In an embodiment of the invention the tire dressing composition comprises less than 10% by weight of volatile organic compounds (VOC). The concentration of VOC is more preferably less than 3% by weight. Certain embodiments of the invention display a viscosity of between 10 cps to 1000 cps. A more preferable viscosity for compositions of the invention range from 100 cps to 500 cps.

Certain embodiments of the invention have a free film tensile strength of greater than or equal to 500 psi, or more preferably 1000 psi. Other embodiments of the invention exhibit a free film elongation (at break) of greater than or equal to 100%, or more preferably greater than or equal to 300%.

According to an embodiment of the invention, the aqueous-based tire dressing composition can suitably be applied to such substrates as automobile tires, bicycle tires and the like. An embodiment of the invention provides a method of forming a dried, resilient, glossy coating on a tire, comprising, applying a tire dressing composition to a surface of a tire. The application of a tire dressing composition to a surface of a tire is not preceded by pre-treatment of the tire or tire surface to polarize or functionalize the elastomers on the tire surface.

The aqueous-based coating composition of the invention may be applied to sidewall of rubber tires using a foam pad. Upon application, the coating composition produces a dried film that is resilient and glossy and has a high tensile strength. Furthermore, embodiments of the invention exhibit a glass transition temperature (Tg) that is lower than or equal to 0° C., or preferably lower than or equal to −10° C. In an embodiment of the invention, the composition adheres well to the rubber surface of the tire sidewall.

### EXAMPLES

The following working examples are further illustrative of the present invention but are in no way intended to limit the scope of the present invention.

### Example 1

| Ingredient | Weight |
|---|---|
| Aqueous polyurethane dispersion | 99.9% |
| Antifoaming agent | 0.1% |
| Total | 100.0% |

The composition given in Example 1 has a viscosity of 600 to 900 cps (Brookfield LVF, 25° C.), and produce a transparent dried film that has a tensile strength no less than 4000 psi and elongation at break is more than 400%. The coating has good adhesion to the tire sidewall and stays flexible at temperature as low as −4° C.

### Example 2

| Ingredient | Weight |
|---|---|
| Aqueous polyurethane dispersion | 65.0% |
| Antifoaming agent | 0.1% |
| DI water | 34.6% |
| Thickener | 0.3% |
| Total | 100.0% |

The coating composition of Example 2 has a viscosity of 150 cps @25° C. and a low V.O.C less than 3.0%. It forms a glossy and transparent dry film and has a strong adhesion to the tire sidewall. The tensile strength and elongation of a free film resulted from the composition are, respectively, higher than 4000 psi and 400%. The coating is water-resistant and its performance will not become affected under 100% humidity conditions over an extended period of time. The coating stays glossy for more than two months. Unlike conventional silicone oil based tire dressing compositions that do not dry over time and are greasy or oily after applied to a tire sidewall and attracts dirt and small road debris, the coating resulted from Example 2 dries to the touch in a short time and will not make your fingers or cloths dirty. It fact, it feels very comfortable to the finger. Any dust or dirt accumulated on the coating can be easily washed away with water. The coating stays resilient at temperature −30° C.

| Ingredient | Weight |
|---|---|
| Aqueous polyurethane dispersion | 60.0% |
| Antifoaming agent | 0.1% |
| DI water | 34.6% |
| Associative thickener | 0.3% |
| Wetting agent | 0.3% |
| UV/visible light absorber | 0.5% |
| Plasticizer | 3.0% |
| Biocide | 0.2% |
| Antioxidant | 1.0% |
| Total | 100.0% |

The coating composition of Example 3 produces a strong, resilient, glossy and transparent dried film. The film has a tensile strength of 4000 psi, and elongation of 400%. It offers many benefits for the protection of the tire sidewall. In addition to the aesthetic effect, the coating provides protection against harmful environmental elements such as UV and ozone. The V.O.C is below 3.0% and the viscosity is 140 cps at 25° C. The coating stays flexible at temperature −30° C.

### Example 4

| Ingredient | Weight |
|---|---|
| Composition given in Example 3 | 96.0% |
| Glittering pigment | 4.0% |
| Total | 100.0% |

The composition in this example produces a sparkling coating that gives an enhanced aesthetic look of the tire in addition to the benefits rendered by Example 3.

### Example 5

| Ingredient | Weight |
|---|---|
| Composition given in Example 2 | 97.0% |
| Carbon black dispersion | 3.0% |
| Total | 100.0% |

The composition in this example produces a shinny black coating that provides with extra protection against UV/visible light in addition to the benefits rendered by Example 2.

### Example 6

| Ingredient | Weight |
|---|---|
| Dow Chemical Styrene-butadiene carboxylated polymer latex | 40.00% |
| Ameripol Synpol SBR emulsion latex | 40.00% |
| Colloid 643 | 0.02% |
| Triton CF10 | 1.00% |
| Sodium 2-pyridinethiol-1-oxide, 40% | 0.10% |
| Natrosol 250MHR | 0.05% |
| Water | 18.83% |
| Total | 100.00% |

The composition in Example 6 produces a dry, shinny, and flexible coating when applied to a tire sidewall if the ambient temperature higher than 10° C. The coating is not as durable as polyurethane based formulas given before.

### Example 7

| Ingredient | Weight |
|---|---|
| Aqueous polyurethane dispersion | 60.0% |
| Antifoaming agent | 0.1% |
| DI water | 39.6% |
| Thickener | 0.3% |
| Total | 100.0% |

The composition given in Example 7 produces a dried film whose elongation at break is less than 70. This value is too low to be flexible enough as a good tire sidewall coating. Therefore, it performs poorly and separation of the coating from the tire sidewall is inevitable under constant stretching/relaxing of the tire when the vehicle is being driven. This example illustrates that a coating composition that produces a dried film whose properties fall outside the range specified earlier does not work within the scope of this invention.

What is claimed is:

1. A method of forming a dried, resilient, glossy coating on a tire, comprising,
applying a tire dressing composition to a surface of a tire, the tire-dressing composition comprising a film-forming polymer liquid dispersion.

2. The method of claim 1 wherein the polymer liquid dispersion is selected from the group consisting of aqueous polyurethane dispersions, urethane acrylic copolymers, natural rubber lattices and synthetic rubber lattices.

3. The method of claim 1 wherein said composition further comprises an antifoaming agent.

4. The method of claim 3 wherein the antifoaming agent is selected from the group consisting of silcone defoamers, silicone antifoamers, non-silicone defoamers, non-silicone antifoamers and mixtures thereof.

5. The method of claim 1 wherein said composition further comprises a wetting agent.

6. The method of claim 5 wherein the wetting agent is selected from the group consisting of non-ionic wetting agents, non-silicone wetting agents and mixtures thereof.

7. The method of claim 1 wherein said composition further comprises a thickener.

8. The method of claim 7 wherein the thickener is selected from the group consisting of acrylic acid-based polymers, hydroxyethylcellulose, polyacrylic-based thickeners, sodium silicate and mixtures thereof.

9. The method of claim 1 wherein said composition further comprises a pigment.

10. The method of claim 9 wherein the pigment is selected from the group consisting of titanium dioxide, carbon black, mica, zinc oxide, calcium carbonate, clay and mixtures thereof.

11. The method of claim 1 wherein said composition further comprises a biocide.

12. The method of claim 11 wherein the biocide is selected from the group consisting of 2-n-octyl-4-isothiazolin-3-one, Polyphase, cationic polymeric biocides, 1,2-benzisothiazolin-3-one, sodium 2-pyridinethiol-1-oxide and mixtures thereof.

13. The method of claim 1 wherein said composition further comprises an antioxidant.

14. The method of claim 13 wherein the antioxidant is selected from the group consisting of hindered phenols, hindered aromatic amines and mixtures thereof.

15. The method of claim 1 wherein said composition further comprises a ultraviolet/visible light stabilizer.

16. The method of claim 15 wherein the light stabilizer is selected from the group consisting of carbon black, micronized titanium dioxide, organic stabilizer compounds and mixtures thereof.

17. The method of claim 1 wherein said composition further comprises a coalescent.

18. The method of claim 17 wherein the coalescent is selected from the group consisting of ester alcohols, glycol methyl ethers and mixtures thereof.

19. The method of claim 1 wherein said composition further comprises a plasticizer.

20. The method of claim 19 wherein the plasticizer is selected from the group consisting of polypropylene glycol dibenzoate, alkyl benzyl phthalates, 2,2,4-trimethyl-1,3-pentanediol diisobutyrate, bis(2-ethylhexyl) phthalate, benzoate esters, and mixtures thereof.

21. The method of claim 1 wherein said composition further comprises an adhesion promoter.

22. The method of claim 21 wherein the adhesion promoter is selected from the group consisting of aminopropyltriethoxysilane, diaminosilane, triaminosilane, chlorosilane, organofunctional silane, alkylsilanes and mixtures thereof.

23. The method of claim 1 wherein said composition further comprises a leveling agent.

24. The method of claim 23 wherein the leveling agent is selected from the group consisting of polyamides, tributoxyethyl phosphate and mixtures thereof.

25. The method of claim 1 wherein the tire surface is not pre-treated to functionalize or polarize the elastomers on the tire surface.
